(19) United States
(12) Patent Application Publication
(10) Pub. No.: US 2007/0269269 A1
(43) Pub. Date: Nov. 22, 2007

(54) Fiber optic installation method

(76) Inventors: Martin Coronado, Cypress, TX (US); Luis Mendez, Houston, TX (US)

Correspondence Address: CANTOR COLBURN, LLP, 55 GRIFFIN ROAD SOUTH, BLOOMFIELD, CT, 06002, US

(21) Appl. No.: 11/436,693

(22) Filed: May 18, 2006

(51) Int. Cl. F16L 1/028

(52) U.S. Cl. 405/158

(57) ABSTRACT

A flexible pipe pig includes a grouping of a plurality of individual piglets and at least one flexible member interconnecting piglets. An optic fiber for installation in an extended conduit. The fiber includes a length of optic fiber and at least one flexible pipe pig attached thereto. A method for preparing an optic fiber for installation through a conduit. The method includes attaching a flexible pipe pig, having a grouping of a plurality of piglets, to the optic fiber. A pipe pig including a body having a non-deflected outside dimension in a single cross-section of the body, which represents a largest transaxial cross-section of the body, the cross-section of the body being smaller than an inside dimension of a conduit through which the pipe pig is intended to be run.

### BACKGROUND

In the hydrocarbon exploration and recovery industry, increasing use has been made of intelligent well completions particularly with respect to sensors and sensorial apparatus deployed within the downhole environment. Signals are passed between and among the downhole and surface environments by means of hydraulic lines, electric lines, optic fibers, wireless transmission means, etc. As the art has learned more about how to handle fiber optic lines in the downhole environment their use has increased. As one of ordinary skill in the art is aware, such fibers may be used at great depths within the wellbore. Often, pump down methods for installing optic fibers are utilized. In such method, velocity of a viscous fluid within a protective conduit is utilized to “drag” the optic fiber through the conduit. This method works well for shorter lengths of conduit but begins to experience decay in efficiency at long conduit lengths. This is because in order to frictionally couple the fiber to the fluid, higher viscosity fluid is needed, such as oil. This fluid also frictionally couples to the conduit inner wall with increasing total friction as the length of the conduit increases. As friction builds within the conduit with increasing length thereof the velocity of the fluid decreases. In order to maintain fluid velocity, the applied fluid pressure at the surface must be increased. As there is a practical limit to the ability to maintain fluid velocity, pumping fiber beyond a certain length of the protective conduit is generally not done. In order to overcome this, the art has attempted to utilize “pipe pigs” attached at the leading end of the optic fiber to draw the rest of the fiber through the conduit. Such pigs generally have a much larger outside dimension than the fiber itself. It is the larger dimension that enables the fluid pressure within the conduit to forcibly move the optic fiber further through the conduit. Unfortunately, such attempts have met with somewhat disappointing results in the downhole environment since bends in the conduit downhole are common. Bends are a problem because the pigs utilized are not capable of traversing such bends. Since, as noted, bends are prevalent in the downhole environment for a host of reasons, utilizing pigs to draw optic fiber has neither been very effective nor well received by the art. This, of course leaves, the initial problem of a practical limit to the distance through a conduit that an optic fiber may be pumped.

### SUMMARY

Disclosed herein is a flexible pipe pig. The pig includes a grouping of a plurality of individual piglets and at least one flexible member interconnecting adjacent piglets.

Further disclosed herein is an optic fiber for installation in an extended conduit. The fiber includes a length of optic fiber and at least one flexible pipe pig attached thereto. The Pig includes a grouping of a plurality of piglets. The pig is attached to the optic fiber.

Further disclosed herein is a method for preparing an optic fiber for installation through a conduit. The method includes attaching a flexible pipe pig, having a grouping of a plurality of piglets, to the optic fiber.

Yet further disclosed herein is a method for installing optic fiber through an extended length conduit. The method includes introducing a fluid into a conduit, the fluid causing movement of the optic fiber through the conduit by causing a lower pressure environment ahead of a flexible pipe pig, having a grouping of a plurality of piglets, of the flexible pipe pig through the conduit.

Yet further disclosed herein is a pipe pig including a body having a non-deflected outside dimension in a single cross-section of the body, which represents a largest transaxial cross-section of the body, the cross-section of the body being smaller than an inside dimension of a conduit through which the pipe pig is intended to be run.

### BRIEF DESCRIPTION OF THE DRAWING

Referring now to the drawings wherein like elements are numbered alike in the several Figures:

FIG. 1 is a schematic cross-sectional illustration of a flexible pipe pig installed at the end of an optic fiber within a tubular structure;

FIG. 2 is a schematic illustration of a flexible pipe pig disposed at the end of an optic fiber wherein the pipe pig illustrates flexibility in its form;

FIG. 3 is a schematic illustration of a flexible pipe pig having individual piglets of varying external dimension;

FIG. 4 is a schematic illustration of a single-part pipe pig; and

FIG. 5 is a schematic illustration of a conical or frustoconical pig.

### DETAILED DESCRIPTION

Referring to FIG. 1, a flexible pipe pig not having the operational restrictions of pipe pigs of the prior art is illustrated generally at 10 and comprises a grouping of a plurality of piglets. In this embodiment three individual piglets 12 (it will be understood that more or fewer piglets may be employed without departing from the scope of this disclosure) are connected to one another by at least one flexible member 14, the member(s) being sufficiently strong and durable to survive the environment in which it is intended to be used. The member(s) may comprise plastic, metal, glass or even may comprise the optic fiber itself. Each piglet comprises a material capable of withstanding the same environment. Primarily, the environment envisioned is the downhole environment of a hydrocarbon installation, but other environments are also contemplated to become home to the flexible pipe pig and are therefore to be considered in selecting a material. A few examples of materials contemplated, and by no means an exhaustive list, include metal, plastic, rubber, ceramic, etc.

It is to be understood in this disclosure that with a greater number of piglets, the largest outside dimensions of each piglet may be smaller while maintaining the same driving force. Each piglet creates some of the driving force desired by creating a low-pressure zone downstream of the piglet. While a greater lower (more relatively negative) pressure is created with a smaller difference between the outside dimension of the piglet and the inside dimension of the conduit, the greater is the change that such piglet will get stuck. By adding piglets and thus low-pressure zones, the size may be reduced and the total driving force maintained while the tendency to get stuck is also reduced.

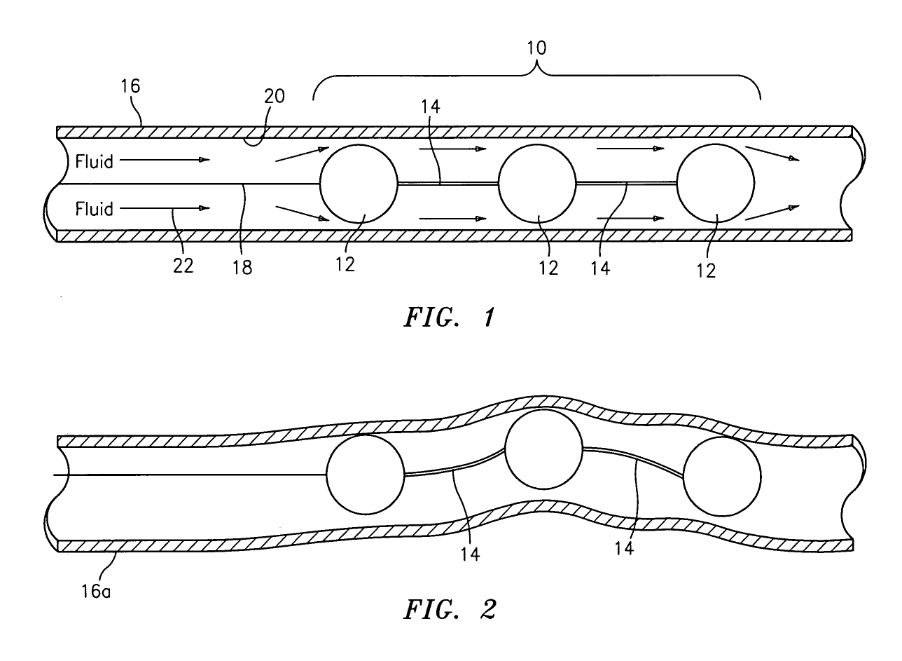

In the illustrated embodiment, each piglet 12 is spaced from an adjacent piglet by an appropriate distance to accomplish the goal of flexibility and movement and in one embodiment, by about ¼ inch to about 5 inches in order to provide for maximum flexibility while still providing optimum optic fiber pulling capability. Again, in the illustrated embodiment, each piglet 12 is generally spherically formed having a diameter of less than an inside diameter of a fiber optic conduit 16 through which the pipe pig 10 and connected optic fiber 18 (or fibers) is (are) intended to travel. The degree to which the spherical piglet is smaller in diameter than the inside dimension (ID) 20 of the fiber optic conduit 16 is in the range of about 70% to about 95% as such range causes fluid (liquid or gas; this structure enables the use of very low viscosity fluid.), illustrated by arrows 22, pumped through the conduit 16 to move around the outside dimension of each piglet 12 in such a manner as to cause a pressure drop in fluid pressure ahead of the piglet relative to the higher pressure behind the piglet to move the piglet through the conduit. The pressure drop functions as a resultant force to move the piglet, and thereby anything connected thereto, toward the lower pressure. The size is also configured to create a feature (e.g. a plug) drivable by pressure (positive displacement) within the optic fiber conduit 16 from the remote location as a component of the motive force for moving the optic fiber. The degree of positive displacement force versus the low-pressure resultant force is a function of the size of the piglet relative to the ID of the conduit. When each piglet is appropriately sized for the conduit within which it will be run, the size provides a synergistic relationship between low-pressure-based movement and positive displacement-based movement. These two movement sources optimally move the flexible pig 10 through the conduit, drawing therewith the one or more optic fiber(s) (or other lines) 18 connected thereto. Piglets in different embodiments may be of the same shape in a flexible pig, individually different shaped piglets in a pig, and different shapes among different pigs while individual pigs have similarly shaped piglets. It should be appreciated, that the selection of geometry of each piglet will likely affect the ability of the flexible pig 10 to move through bends in the optic fiber conduit 16. An illustration of the flexible pig 10 moving through the bend in a conduit 16a is provided in FIG. 2. It will be easily appreciated by one of ordinary skill in the art that a prior art pipe pig could not have moved through this bent section of conduit 16a illustrated in FIG. 2. The spherical piglets 12 of FIG. 1 in conjunction with flexible members 14, for example, facilitate easy translation of each piglet relative to each other piglet to enable movement through the bent section. It should further be noted that the spherical shapes and semispherical shapes facilitate movement through tighter bend radiuses than other shapes simply because of the ability of the shape to pivot on its own center point without representing an increased radius regardless of bend angle.

The piglets may be attached to members 14, or to the optic fiber 18 itself, by means of glue, fusing, molding, etc. The attachment must be strong enough to allow the flexible pipe pig to pull the optic fiber through the conduit.

In an alternate embodiment of the invention disclosed herein, more than one individual flexible pipe pig is utilized along the length of the optic fiber to be installed into an extended conduit. This embodiment will appear as does the FIG. 1 embodiment but the flexible pipe pig will repeat over a distance much too great to be illustrated directly. Each flexible pig will be disposed at a selected length interval along the optic fiber of, for example, 1,000 feet. It will be understood that greater or lesser intervals are contemplated and that both equal length intervals and unequal length intervals are contemplated. Moreover, it is further contemplated that individual piglets may be employed upon the fiber or fibers to be installed in a conduit over an extended length of the fiber or even over the entire length of the fiber at selected length intervals between each piglet and with a complete flexible pig at least somewhere along the line being installed. The appearance of such will be as is FIG. 1 but the piglets will simply continue to occur along the optic fiber at some selected interval. This may be beneficial in some instances in order to distribute the load placed upon the fiber over a greater length of the fiber.

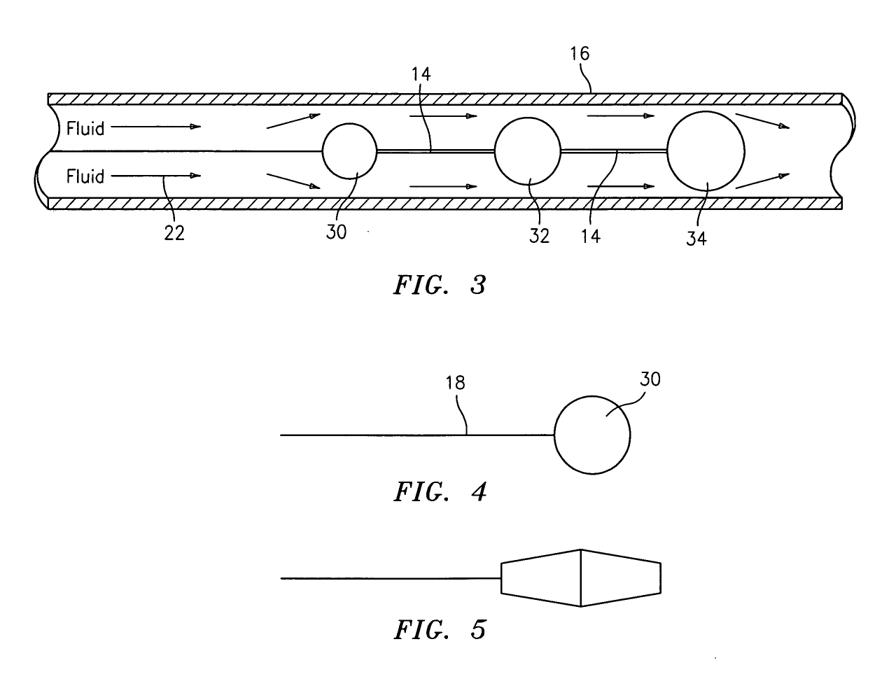

In another embodiment, the external dimensions of individual piglets in a flexible pipe pig will vary, referring to FIG. 3. The figure illustrates a flexible pipe pig with a grouping of three piglets 30, 32, and 34, each progressively growing in outside dimension as they approach the lead piglet (piglet 34), which is the largest of the grouping. The growing size of piglets facilitates a more laminar flow of fluid around the pig itself such that lower pressure areas behind the pig are avoided. Turbulence is likewise minimized. As such the resultant motive force imparted on the pipe pig is greater to move the pig in the desired direction. The fluid flow is increasingly choked off until it reaches the lead piglet and creates the desired lower pressure ahead of the pig. In addition, since in this embodiment there is only one “large” piglet, the entire pig has greater flexibility through bends in the conduit.

In another embodiment, a vacuum source is connected to a return line of the conduit. Such vacuum source will create a lower pressure environment ahead of the first piglet in a flexible pig at the leading end of the line being installed. The vacuum source may be employed alone, with no fluid pressure from behind the flexible pig or may be employed in conjunction with the fluid discussed above in this disclosure.

In yet another embodiment, referring to FIG. 4, a single-part pipe pig 30 is utilized and remains in effect “flexible” because of its shape, which allows for significant off axis movement without becoming jammed in a conduit that includes bends therein. The shape of such pig in one iteration is ellipsoidal which is defined as “a surface all plane sections of which are ellipses or circles.” Clearly, this term includes spherical objects, which is intended herein. Moreover, in another iteration, the shape may be that of a pair of cones or of frustocones (see FIG. 5) axially joined at their respective bases. Other shapes having a configuration that presents a transaxial cross-section that is a largest dimension and all other cross sections are smaller in dimension are equally applicable because they provide for fluid restriction at the large transaxial cross section such that the desired low pressure is created downstream of the pig and yet eliminate dimensions ahead of and behind that cross section that would otherwise tend to become jammed.

While this disclosure has discussed optic fibers specifically, it is to be appreciated that the flexible pipe pig disclosed herein is capable of being used for the installation of any flexible line into a conduit, including an extended length conduit.

While preferred embodiments have been shown and described, modifications and substitutions may be made thereto without departing from the spirit and scope of the invention. Accordingly, it is to be understood that the present invention has been described by way of illustrations and not limitation.

1. A flexible pipe pig comprising:
a grouping of a plurality of individual piglets; and
at least one flexible member interconnecting adjacent piglets.

2. A flexible pipe pig as claimed in claim 1 wherein each of the plurality of piglets is located proximate the next adjacent piglet.

3. A flexible pipe pig as claimed in claim 1 wherein each of the plurality of piglets is located within about ¼ to about 5 inches of the next adjacent piglet.

4. A flexible pipe pig as claimed in claim 1 wherein each of the plurality of piglets is similarly shaped.

5. A flexible pipe pig as claimed in claim 1 wherein each of the plurality of piglets is differently shaped.

6. A flexible pipe pig as claimed in claim 1 wherein at least one of the plurality of piglets is spherically shaped.

7. A flexible pipe pig as claimed in claim 1 wherein the outside dimension of at least one of the plurality of piglets is sized relative to a conduit in which it is intended to be used such that fluid flow therepast within the conduit is restricted.

8. A flexible pipe pig as claimed in claim 1 wherein the flexible member is an optic fiber.

9. A flexible pipe pig as claimed in claim 1 wherein the flexible pipe pig is fixedly attachable to an optic fiber.

10. An optic fiber for installation in an extended conduit, the fiber comprising:
a length of optic fiber; and
at least one flexible pipe pig comprising a grouping of a plurality of piglets attached to the optic fiber.

11. An optic fiber for installation in an extended conduit as claimed in claim 10 wherein said flexible pipe pig comprises:
a grouping of a plurality of individual piglets; and
at least one flexible member interconnecting adjacent piglets.

12. An optic fiber for installation in an extended conduit as claimed in claim 11 wherein said flexible connector is the optic fiber itself.

13. An optic fiber for installation in an extended conduit as claimed in claim 10 wherein a number of said flexible pipe pigs are disposed at selected length intervals along said optic fiber.

14. An optic fiber for installation in an extended conduit as claimed in claim 10 further including at least one additional piglet located at said fiber and spaced from said flexible pig.

15. An optic fiber for installation in an extended conduit as claimed in claim 13 wherein said selected length intervals are equivalent to one another.

16. An optic fiber for installation in an extended conduit as claimed in claim 13 wherein said selected length intervals are not equivalent to one another.

17. An optic fiber for installation in an extended conduit as claimed in claim 10 wherein said at least one optic fiber is a number of optic fibers each attached to the at least one flexible pipe pig.

18. A method for preparing an optic fiber for installation through a conduit comprising:
attaching a flexible pipe pig, having a plurality of piglets, to the optic fiber.

19. A method for installing optic fiber through a conduit as claimed in claim 18 wherein said attaching said at least one pipe pig is attaching a number of pipe pigs to said at least one optic fiber at selected length intervals along said at least one optic fiber.

20. A method for installing optic fiber through an extended length conduit comprising:
introducing a fluid into a conduit, said fluid causing movement of said optic fiber through said conduit by causing a lower pressure environment ahead of a flexible pipe pig, having a grouping of a plurality of piglets, of the flexible pipe pig through the conduit.

21. The method as claimed in claim 20 further including:
introducing a negative pressure to a return line connected with the conduit.

22. A pipe pig comprising:
a body having a non-deflected outside dimension in a single cross-section of the body, which represents a largest transaxial cross-section of the body, the cross-section of the body being smaller than an inside dimension of a conduit through which the pipe pig is intended to be run.

23. A pipe pig as claimed in claim 22, wherein the pig body is an ellipsoid.

24. A pipe pig as claimed in claim 23, wherein the ellipsoid is spherical.

25. A pipe pig as claimed in claim 22, wherein the body is shaped as two cones or as two frustocones joined axially at their respective bases.

26. A pipe pig system for cable running in a conduit comprising one or more pipe pigs, each having a body with a non-deflected outside dimension in a single cross-section of the body, which represents a largest transaxial cross-section of the body, the cross-section of the body being smaller than an inside dimension of a conduit through which the pipe pig is intended to be run, wherein the one or more pipe pigs are attached to the cable.

27. A pipe pig system for cable running in a conduit as claimed in claim 26, where several pipe pigs are attached to the cable at selected length intervals.

28. A pipe pig as claimed in claim 22, wherein the largest transaxial cross-section is about 70% to about 95% of the inside dimension of the conduit.
